(19) United States
(12) Patent Application Publication
(10) Pub. No.: US 2024/0202413 A1
(43) Pub. Date: Jun. 20, 2024

(54) INFORMATION PROCESSING APPARATUS, FUSE SELECTING METHOD AND PROGRAM

(71) Applicant: NIPPON TELEGRAPH AND TELEPHONE CORPORATION, Tokyo (JP)

(72) Inventors: Naoki HANAOKA, Tokyo (JP); Toru TANAKA, Tokyo (JP); Naomichi NAKAMURA, Tokyo (JP); Yuji HIGUCHI, Tokyo (JP)

(21) Appl. No.: 18/555,601

(22) PCT Filed: Apr. 19, 2021
(86) PCT No.: PCT/JP2021/015928

§ 371 Date: Oct. 16, 2023

(51) Int. Cl. G06F 30/367; G06F 119/02; G06F 119/06

(52) U.S. Cl. CPC G06F 30/367; G06F 2119/02; G06F 2119/06

(57) ABSTRACT

An information processing device includes: a data acquisition unit which acquires data indicating characteristics of a power supply system; and a fuse selection unit which selects a fuse to be blown when a short-circuit occurs in the power supply system on the basis of the data.

### TECHNICAL FIELD

The present invention relates to an information processing device, a fuse selection method, and a program.

### BACKGROUND ART

Large-capacity electrolytic capacitors and fuses built into current distribution devices are used for short-circuit protection in indoor DC power supply systems (cable length is several hundred meters or less). At the time of a short-circuit, electric charge is supplied from the large-capacity capacitors to the fuses, blowing the fuses. In outdoor DC power supply systems having long cables (about several thousand meters), large-capacity capacitors cannot be used and short-circuit protection is provided in two stages: the gate block and the fuse of DC/DC converters.

NPL 1 describes a method of designing a high-voltage DC power supply system in consideration of the effects of short-circuit faults.

### CITATION LIST

### Non Patent Literature

[NPL 1] “Toward Realization of High Voltage DC Power Supply Systems”, NTT Technical Journal, August 2009, [online], Internet <URL:https://www.ntt.co.jp/journal/0908/files/jn200908018.pdf>

### SUMMARY OF INVENTION

### Technical Problem

In the technique in the related art, there are no design guidelines for fuse selection in a DC power supply system having a long cable length, such as an outdoor DC power supply system and there is a problem that it is difficult to design short-circuit protection.

An object of the technique described herein is to assist selection of a fuse in a power supply system.

### Solution to Problem

The disclosed technique is an information processing device including: a data acquisition unit which acquires data indicating characteristics of a power supply system; and a fuse selection unit which selects a fuse to be blown when a short-circuit occurs in the power supply system on the basis of the data.

### Advantageous Effects of Invention

It is possible to assist selection of a fuse in a power supply system.

### BRIEF DESCRIPTION OF DRAWINGS

FIG. 1 is a diagram illustrating a system configuration of a power supply system to be determined.

FIG. 2 is a functional configuration diagram of an information processing device.

FIG. 3 is a flowchart for describing an example of a flow of fuse selection processing.

FIG. 4 is a diagram illustrating an outline of an equivalent circuit.

FIG. 5 is a first diagram illustrating an example of a current waveform.

FIG. 6 is a second diagram illustrating an example of a current waveform.

FIG. 7 is a diagram illustrating a hardware configuration example of a computer.

### DESCRIPTION OF EMBODIMENTS

An embodiment (present embodiment) of the present invention will be described below with reference to the drawings. The embodiments which will be described below are merely examples and embodiments to which the present invention is applied are not limited to the following embodiments.

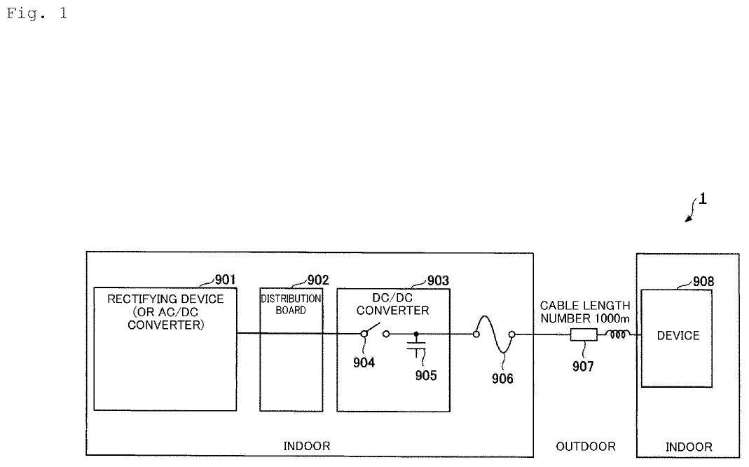

FIG. 1 is a diagram illustrating a system configuration of a power supply system to be determined.

A power supply system 1 to be subjected to a determination process according to the present embodiment is an outdoor DC power supply system and a cable length of a power supply cable is about several thousand meters. The power supply system 1 includes a rectify device (or AC/DC converter) 901, a distribution board 902, a DC/DC converter 903, a fuse 906, a cable impedance 907, and a device 908.

Also, the DC/DC converter 903 includes a gate block 904 and an X capacitor 905.

Since an outdoor DC power supply system cannot use a large-capacity capacitor unlike an indoor DC power supply system, it is difficult to cut the fuse 906. Furthermore, if the cable length of the power supply cable increases, the cable impedance increases and the short-circuit current decreases. Thus, there is a characteristic that the fuse 906 is less likely to blow.

Also, the DC/DC converter 903 has a function of detecting an over-current flowing due to a short-circuit or the like and opening the gate block 904 to stop power supply. However, even after the gate block 904 is opened, the charge stored in X capacitor 905 (several hundred to several thousand uF/kW) incorporated in the output filter of DC/DC converter 903 continues to flow toward the short-circuit point. Thus, even if the gate block 904 operates quickly, the current flowing from the X capacitor 905 may blow the fuse 906.

A method of selecting the fuse 906 having an appropriate rated current for short-circuit protection of the power supply system 1 using the information processing device according to the present embodiment will be described below.

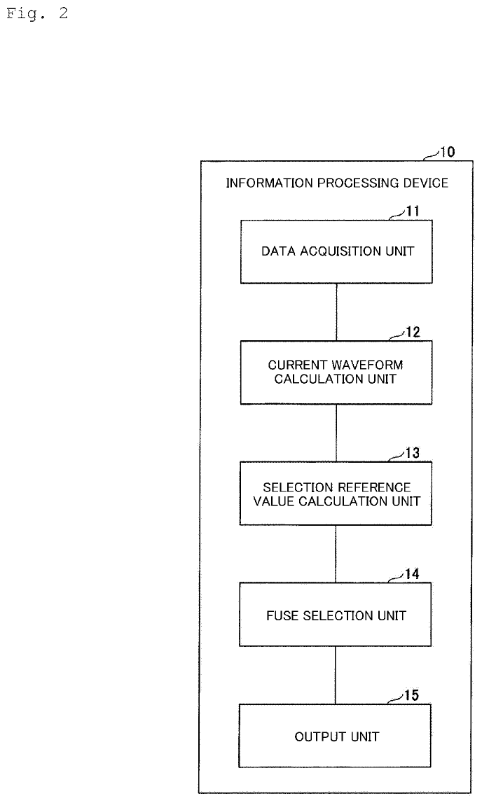

FIG. 2 is a functional configuration diagram of an information processing device.

The information processing device 10 includes a data acquisition unit 11, a current waveform calculation unit 12, a selection reference value calculation unit 13, a fuse selection unit 14, and an output unit 15.

The data acquisition unit 11 acquires data indicating characteristics of the power supply system 1. Specifically, the data acquisition unit 11 acquires data indicating an operation time of a gate block 904 of a DC/DC converter 903 provided in the power supply system 1, a capacity of the X capacitor 905 of the DC/DC converter 903, an impedance of the power supply cable, and fusing characteristics of the fuse 906 included in the power supply system 1. The data acquisition unit 11 may acquire data through a user's input operation or may receive data from another device or the like.

The current waveform calculation unit 12 calculates a current waveform when the power supply system 1 is short-circuited on the basis of the operation time of the gate block 904, the capacity of the X capacitor 905, and the impedance of the power supply cable, among the data acquired by the data acquisition unit 11.

Specifically, the current waveform calculation unit 12 calculates, when the operation time of the gate block 904 is a predetermined threshold value or less, a current waveform when the power supply system 1 is short-circuited on the basis of the capacity of the X capacitor 905 and the impedance of the power supply cable and calculates, when the operation time of gate block 904 exceeds the threshold value, a current waveform when the power supply system 1 is short-circuited on the basis of the capacitance of the X capacitor 905, the impedance of the power supply cable, and the operation time of the gate block 904.

Note that the current waveform calculation unit 12 calculates the current waveform when the power supply system 1 is short-circuited by a simulation of a circuit equivalent to the power supply system 1.

The selection reference value calculation unit 13 calculates a reference value (selection reference value) for selecting the fuse 906 on the basis of the current waveform calculated by the current waveform calculation unit 12. Specifically, the selection reference value calculation unit 13 calculates the total amount of charge (It) flowing through the fuse 906 and the Joule integral value (I²t) at the time of a short-circuit.

The fuse selection unit 14 selects the fuse 906 to blow when a short-circuit occurs on the basis of the calculated selection reference value. Specifically, the fuse selection unit 14 selects the fuse 906 whose calculated total amount of charge (It) exceeds the total limit value of amount of charge obtained from the fusing characteristics of the fuse 906 or whose Joule integral value (I²t) exceeds the limit value of the Joule integral value obtained from the fusing characteristics of the fuse 906. For example, the fuse selection unit 14 selects a fuse on the basis of information indicating fusing characteristics of a plurality of fuses (fusing characteristics information).

Note that the fusing characteristics are, for example, characteristics (I-T characteristics) based on the amount of charge (It) and characteristics (I²t-T characteristics) based on the Joule integral value (I²t). The fuse selection unit 14 calculates the limit value of the total amount of charge on the basis of the I-T characteristics, and calculates the limit value of the Joule integral value on the basis of the I²t-T characteristics. Here, the fusing characteristics are not limited to these and other characteristics may be used.

The output unit 15 outputs the selection result of the fuse selection unit 14. The output unit 15 may transmit information indicating the selection result to another device or may display a screen indicating the selection result.

### (Operation of Information Processing Device 10)

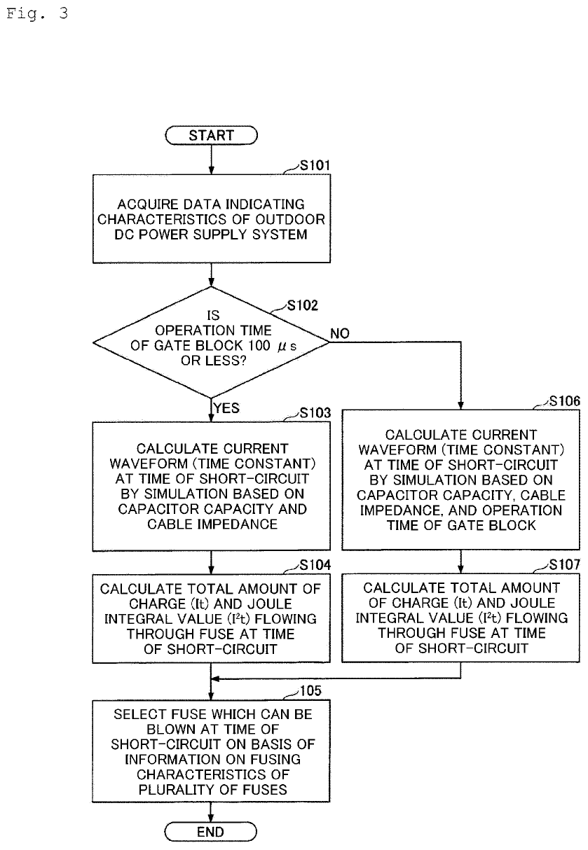

An operation of the information processing device 10 will be described below. FIG. 3 is a flowchart for describing an example of the flow of short-circuit determination processing.

When a failure occurs in the power supply system 1, an operation by a user such as an administrator of the power supply system 1 is received to start short-circuit determination processing.

The data acquisition unit 11 acquires data indicating characteristics of the power supply system 1, which is an outdoor DC power supply system (Step S101). Pieces of data indicating the characteristics of the power supply system 1 include the operation time of the gate block 904 of the DC/DC converter 903 provided in the power supply system 1, the capacity of the X capacitor 905 of the DC/DC converter 903, the impedance of the power supply cable, and the fusing characteristics of the fuse 906 provided in the power supply system 1.

Subsequently, the current waveform calculation unit 12 determines whether the operation time of the gate block 904 is 100 μs or less (Step S102). Note that 100 μs is a preset value as a predetermined threshold value.

If it is determined that the operation time of the gate block 904 is 100 μs or less (Step S102: Yes), the current waveform calculation unit 12 calculates a current waveform (time constant) at the time of a short-circuit by simulation based on the capacitor capacity and the cable impedance (Step S103). This simulation is a simulation using an equivalent circuit which will be described later.

Subsequently, the selection reference value calculation unit 13 calculates the total amount of charge (It) flowing through the fuse at the time of a short-circuit and the Joule integral value (I²t) (Step S104). Furthermore, the fuse selection unit 14 selects a fuse which can be blown during a short-circuit on the basis of the fusing characteristic information of the plurality of fuses (Step S105).

Also, if it is determined that the operation time of the gate block 904 is not 100 μs or less (Step S102: No) in the process of step S102, the current waveform calculation unit 12 calculates a current waveform (time constant) at the time of a short-circuit by simulation based on the capacitor capacity, the cable impedance, and the operation time of the gate block (Step S106).

Subsequently, the selection reference value calculation unit 13 calculates the total amount of charge (It) flowing in the circuit at the time of a short-circuit and the Joule integral value (I²t) (Step S107). Furthermore, the fuse selection unit 14 selects a fuse which can be blown at the time of a short-circuit on the basis of the fusing characteristic information of the plurality of fuses (Step S105).

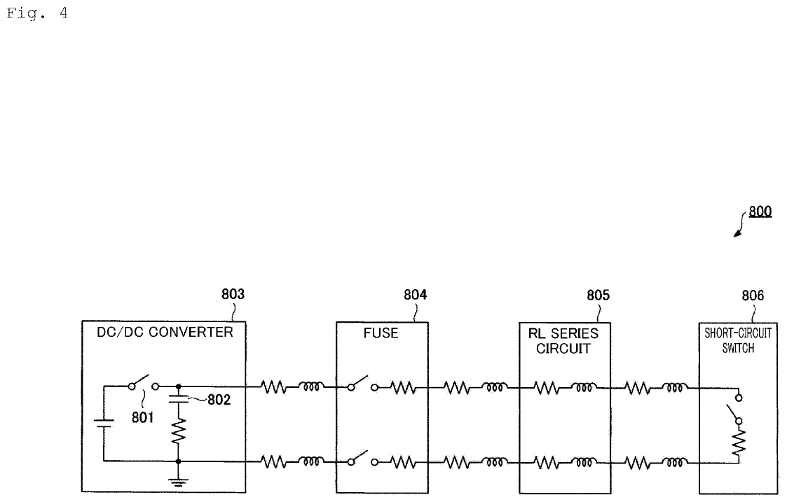

FIG. 4 is a diagram illustrating an outline of an equivalent circuit. An equivalent circuit 800 is used in Steps S103 and S108 shown in FIG. 3.

The equivalent circuit 800 includes a DC/DC converter 803, a fuse 804, an RL series circuit 805, and a short-circuit switch 806. The DC/DC converter 803 includes a gate block 801 and an X capacitor 802.

In Step S103, the current waveform calculation unit 12 calculates the total amount of charges It and I²t flowing through the fuse 804 without considering the operation time of the gate block because the operation time of the gate block is short.

In addition, in Step S108, since the operation time of the gate block is long, assuming that the charge from the X capacitor 802 and the charge from the gate block 801 flow through the fuse 804, the current waveform calculation unit 12 calculates the total amount of charge It and I²t flowing through the fuse 804 in accordance with the operation time of the gate block.

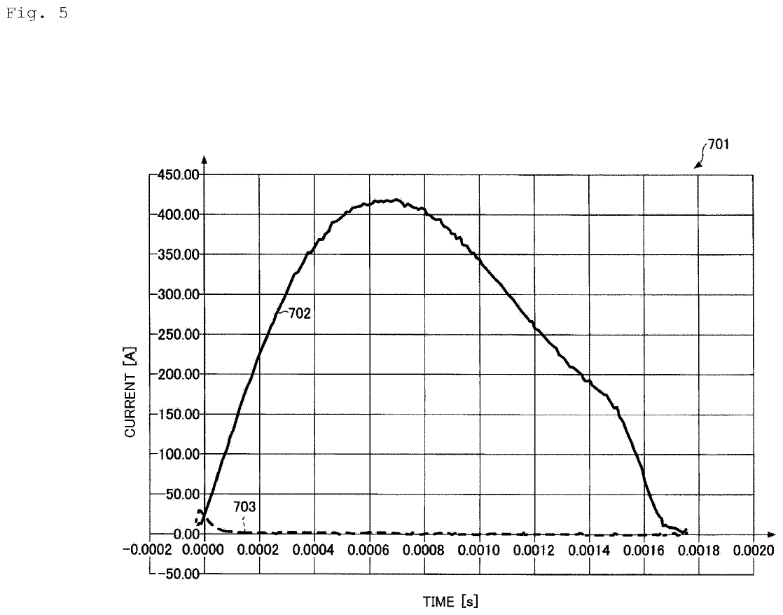

FIG. 5 is a first diagram illustrating an example of a current waveform.

A graph 701 is an example of a current waveform calculated in Step S103. A current waveform 702 representing the current flowing through the fuse 804 and a current waveform 703 representing the current flowing through the gate block 801 are shown. In this case, since almost no current flows through the gate block 801, the current waveform 702 matches the current waveform representing the current flowing through the X capacitor 802.

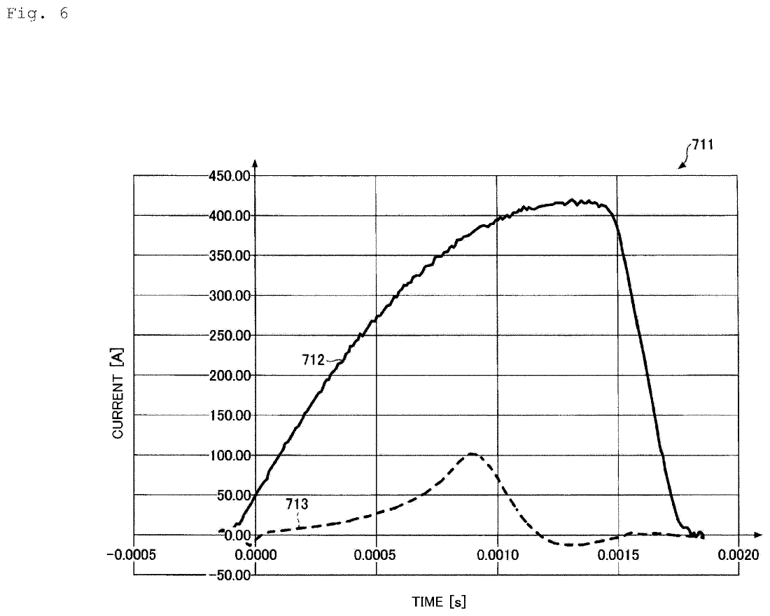

FIG. 6 is a second diagram illustrating an example of a current waveform.

A graph 711 is an example of a current waveform calculated in Step S108. A current waveform 712 representing the current flowing through the fuse 804 and a current waveform 713 representing the current flowing through the gate block 801 are shown. In this case, the current waveform representing the sum of the current flowing through the X capacitor 802 and the current flowing through the gate block 801 becomes the current waveform representing the current flowing through the fuse 804.

According to the information processing device 10 relating to the present embodiment, a fuse which blows at the time of a short-circuit is selected in an outdoor DC power supply system with a long cable length. This can assist in the selection of fuses in the power supply system.

### (Hardware Configuration Example of Information Processing Device 10)

The information processing device 10 can be realized, for example, by causing a computer to execute a program describing the processing details described in the present embodiment. Note that this “computer” may be a physical machine or a virtual machine on the cloud. When using a virtual machine, the “hardware” described herein is virtual hardware.

The above program can be recorded in a computer-readable recording medium (portable memory or the like), saved, or distributed. It is also possible to provide the above program through a network such as the Internet or e-mail.

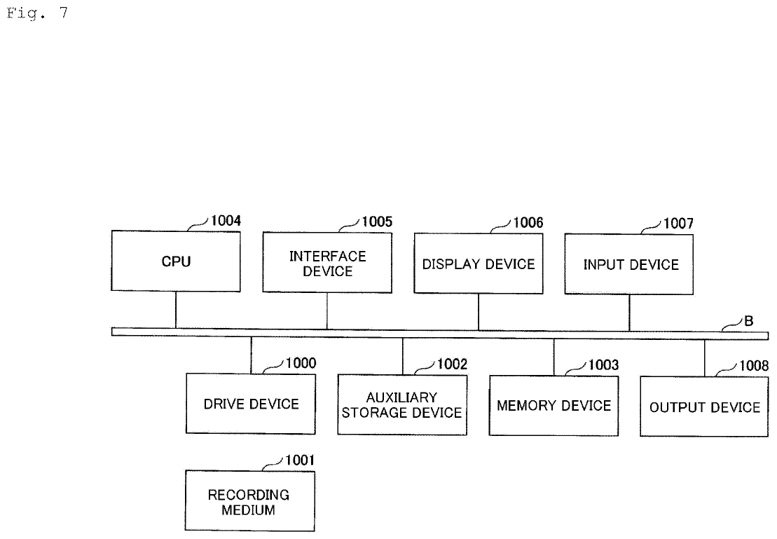

FIG. 7 is a diagram illustrating a hardware configuration example of the computer. The computer in FIG. 7 has a drive device 1000, an auxiliary storage device 1002, a memory device 1003, a CPU 1004, an interface device 1005, a display device 1006, an input device 1007, an output device 1008, and the like which are connected to each other via a bus B, respectively.

A program for realizing processing by the computer is provided by, for example, a recording medium 1001 such as a CD-ROM or a memory card. When the recording medium 1001 storing a program is set in the drive device 1000, the program is installed from the recording medium 1001 to the auxiliary storage device 1002 via the drive device 1000. Here, the program need not necessarily be installed from the recording medium 1001 and may be downloaded from another computer via the network. The auxiliary storage device 1002 stores installed programs as well as necessary files, data, and the like.

The memory device 1003 reads the program from the auxiliary storage device 1002 and stores it when a program activation instruction is received. The CPU 1004 implements functions related to the device in accordance with programs stored in the memory device 1003. The interface device 1005 is used as an interface for connecting to a network. A display device 1006 displays a graphical user interface (GUI) or the like by a program. An input device 1007 is composed of a keyboard, a mouse, buttons, a touch panel, or the like and is used for inputting various operational instructions. The output device 1008 outputs the calculation result.

### Summary of Embodiment

This specification describes at least an information processing device, a fuse selection method, and a program described in each of the following items.

### (Item 1)

An information processing device including:
a data acquisition unit which acquires data indicating characteristics of a power supply system; and
a fuse selection unit which selects a fuse to be blown when a short-circuit occurs in the power supply system on the basis of the data.

### (Item 2)

The information processing device according to Item 1, wherein the data acquisition unit acquires the data indicating an operation time of a gate block of a DC/DC converter included in the power supply system, a capacity of an X capacitor of the DC/DC converter, an impedance of a power supply cable, and fusing characteristics of a fuse included in the power supply system.

### (Item 3)

The information processing device according to Item 2, further including:
a current waveform calculation unit which calculates a current waveform when the power supply system is short-circuited on the basis of the operation time of the gate block, the capacity of the X capacitor, and the impedance of the power supply cable; and
wherein the fuse selection unit selects a fuse to be blown when the short-circuit occurs on the basis of the calculated amount of charge or the Joule integral value and the fusing characteristic of the fuse.

### (Item 4)

The information processing device according to Item 3, wherein the current waveform calculation unit calculates, when the operation time of the gate block is a predetermined threshold value or less, a current waveform when the power supply system is short-circuited on the basis of the capacity of the X capacitor and the impedance of the power supply cable and calculates, when the operation time of gate block exceeds the threshold value, a current waveform when the power supply system is short-circuited on the basis of the capacitance of the X capacitor, the impedance of the power supply cable, and the operation time of the gate block.

### (Item 5)

The information processing device according to Item 4, wherein the fuse selection unit selects a fuse to be blown when the short-circuit occurs on the basis of information indicating fusing characteristics of a plurality of fuses.

### (Item 6)

The information processing device according to any one of Items 3 to 5, wherein the current waveform calculation unit calculates the current waveform when the power supply system is short-circuited by a simulation in a circuit equivalent to the power supply system.

### (Item 7)

A fuse selection method performed by a computer including:
a step of acquiring data indicating characteristics of a power supply system; and
a step of selecting a fuse to be blown when a short-circuit occurs in the power supply system on the basis of the data.

### (Item 8)

A program causing a computer to function as each of the units in the information processing device according to any one of Items 1 to 6.

Although the present embodiment has been described above, the present invention is not limited to such a specific embodiment and various modifications and changes are possible within the scope of the gist of the invention described in the claims.

### REFERENCE SIGNS LIST

1 Power supply System
10 Information processing device
11 Data acquisition unit
12 Current waveform calculation unit
13 Selection reference value calculation unit
14 Fuse selection unit
15 Output unit
801 Gate block
802 X capacitor
803 DC/DC converter
804 Fuse
805 RL series circuit
806 Short-circuit switch
901 Rectifying device (or AC/DC converter)
902 Distribution board
903 DC/DC converter
904 Gate block
905 X capacitor
906 Fuse
907 Cable impedance
908 Device
1000 Drive device
1001 Recording medium
1002 Auxiliary storage device
1003 Memory device
1004 CPU
1005 Interface device
1006 Display device
1007 Input device
1008 Output device

1. An information processing device, comprising:
a memory, and
a processor configured to:
acquire data indicating characteristics of a power supply system; and
select a fuse to be blown when a short-circuit occurs in the power supply system on a basis of the data.

2. The information processing device according to claim 1, wherein the processor acquires the data indicating an operation time of a gate block of a DC/DC converter included in the power supply system, a capacity of an X capacitor of the DC/DC converter, an impedance of a power supply cable, and fusing characteristics of a fuse included in the power supply system.

3. The information processing device according to claim 2, wherein the processor is further configured to:
calculate a current waveform when the power supply system is short-circuited on a basis of the operation time of the gate block, the capacity of the X capacitor, and the impedance of the power supply cable; and
calculate an amount of charge (It) or a Joule integral value (I²t) which flows through a fuse at a time of a short-circuit on a basis of the calculated current waveform,
wherein the processor selects the fuse to be blown when the short-circuit occurs on a basis of the calculated amount of charge or the Joule integral value and the fusing characteristic of the fuse.

4. The information processing device according to claim 3, wherein the processor calculates, when the operation time of the gate block is a predetermined threshold value or less, a current waveform when the power supply system is short-circuited on a basis of the capacity of the X capacitor and the impedance of the power supply cable, and calculates, when the operation time of gate block exceeds the predetermined threshold value, a current waveform when the power supply system is short-circuited on the basis of the capacitance of the X capacitor, the impedance of the power supply cable, and the operation time of the gate block.

5. The information processing device according to claim 4, wherein the processor selects the fuse to be blown when the short-circuit occurs on a basis of information indicating fusing characteristics of a plurality of fuses.

6. The information processing device according to any one of claim 3, wherein the processor calculates the current waveform when the power supply system is short-circuited by a simulation in a circuit equivalent to the power supply system.

7. A fuse selection method performed by a computer including a memory and a processor, the method comprising:
acquiring data indicating characteristics of a power supply system; and
selecting a fuse to be blown when a short-circuit occurs in the power supply system on a basis of the data.

8. A non-transitory computer-readable recording medium having computer-readable instructions stored thereon, which, when executed, cause a computer including a memory and processor to function as the information processing device according to claim 1.
